(19) United States
(12) Patent Application Publication
(10) Pub. No.: US 2009/0290613 A1
(43) Pub. Date: Nov. 26, 2009

(54) EXTERNAL CAVITY LASER ASSEMBLY INCLUDING EXTERNAL CHIRPED EXIT REFLECTOR FOR IMPROVED LINEARITY

(75) Inventors: Jun Zheng, Houston, TX (US); Chung-Yung Wang, Sugar Land, TX (US); Hung-Lun Chang, Sugar Land, TX (US)

Correspondence Address: APPLIED OPTOELECTRONICS, INC., 13115 JESS PIRTLE BLVD., SUGAR LAND, TX, 77478, US

(73) Assignee: APPLIED OPTOELECTRONICS, INC., Sugar Land, TX (US)

(21) Appl. No.: 12/124,300

(22) Filed: May 21, 2008

(51) Int. Cl. H01S 3/08

(52) U.S. Cl. 372/99

(57) ABSTRACT

An external cavity laser assembly includes an external chirped exit reflector configured to reduce changes in reflectivity, thereby improving linearity. The chirped exit reflector may be configured to provide a reflectivity profile with a substantially flat peak portion, for example, as compared to the reflectivity profile of a uniform period fiber Bragg grating. The chirped exit reflector may also be configured such that an optical cavity length of the external cavity laser is shorter for higher wavelengths, thereby reducing wavelength fluctuations and changes in reflectivity caused by wavelength fluctuations.

### TECHNICAL FIELD

The present invention relates to external cavity lasers and, in particular, to an external cavity laser assembly including an external chirped exit reflector for improved linearity.

### BACKGROUND INFORMATION

Semiconductor lasers may be used in a variety of industrial and scientific applications, such as optical communications. Optical communications applications, for example, may employ lasers that emit light at a particular lasing wavelength (e.g., 1.31 μm or 1.55 μm) suitable for transmission through optical fibers. Semiconductor lasers may be desirable over other types of lasers because they have a relatively small volume and consume a relatively small amount of power.

Lasers generally include a laser cavity defined by mirrors or reflectors and an optical gain medium between the reflectors in the laser cavity. When pumped with pumping energy (e.g., an electrical current), the gain medium amplifies electromagnetic waves (e.g., light) in the cavity by stimulated emission, thereby providing optical gain and generating a laser light output. In semiconductor lasers, a semiconductor active layer or region serves as the gain medium and reflectors provide optical feedback for laser oscillation within the active region. In Fabry-Perot lasers, for example, a set of mirrors or cleaved facets bound the active region to provide the optical feedback. In other semiconductor lasers, such as distributed feedback (DFB) lasers and distributed Bragg reflector (DBR) lasers, one or more diffraction gratings (e.g., Bragg gratings) may be used to provide reflectance. In a DBR laser, a Bragg grating is used as a reflector at one or both ends of the active region. In a DFB laser, a distributed reflector (e.g., a diffraction grating or Bragg grating) along the active region provides the optical feedback and may be used to restrict oscillation to a single mode.

Electrically pumped semiconductor lasers are pumped by applying an electrical current to the active region of the semiconductor laser. The optical output of the laser may thus be modulated directly by driving the laser with a modulated current. In optical transmitters, for example, the electrical current that drives the laser may be modulated with a wide-band RF signal and the semiconductor laser (e.g., a single mode DFB laser diode) may be directly modulated to transmit the wide-band RF signal over optical fiber.

The modulated current injected into the active region of a semiconductor laser (e.g., in a directly-modulated semiconductor laser) may affect the optical index of the waveguide, which may change the effective optical cavity length and the effective pitch of a grating in a DFB laser. As a result, the modulated current injected into the gain region of the laser may cause unwanted modulation of wavelength and/or optical mode field distribution within the cavity. The modulation of wavelength (referred to as “chirp”) may lead to distortion of the modulated optical signal, for example, if the optical transmission path includes an optical FM to AM converter such as an etalon or non-zero dispersion fiber. Modulation of the optical mode field distribution within the cavity may lead to distortion in the modulated output of the laser due to shifting of power from the front to rear of the laser cavity and vice-versa.

Chirp may be reduced by moving the distributed feedback element (e.g., the grating) to a separate section of the laser that is not affected by the modulating current, such as in a DBR laser or an external cavity fiber Bragg grating (FBG) laser. In such lasers, however, the gain section may still produce an index change when modulated, which may change the phase of the optical mode relative to the external grating. This may lead to dynamic shifting of front to rear power distribution, which is often a major source of non-linear output when directly modulating such a laser.

As illustrated by the reflectivity profile 100 shown in FIG. 1, for example, a conventional external reflector, such as a uniform period fiber Bragg grating, may provide a reflectivity R₁ for a wavelength λ₁ emitted from an active region of a laser at a given drive current. Changes in the input current due to the modulation may change the refractive index n of the active region, which changes the phase of the optical mode of the laser relative to the external reflector. In particular, an increase in the refractive index n may cause the laser wavelength to increase to a greater wavelength λ₂, which causes the reflectivity of the conventional external reflector to increase to R₂. As a result, the reflectivity ratio of the rear reflector and external exit reflector is changed, thus shifting power from front to rear of the laser cavity, or vice-versa, and causing a non-linear output.

### BRIEF DESCRIPTION OF THE DRAWINGS

These and other features and advantages will be better understood by reading the following detailed description, taken together with the drawings wherein:

FIG. 1 is a diagram of a reflectivity profile of a uniform period fiber Bragg grating;

FIG. 2 is a schematic diagram of an external cavity laser assembly including an external chirped exit reflector, consistent with an embodiment of the present invention;

FIG. 3 is a diagram of a reflectivity profile of an external chirped exit reflector, consistent with an embodiment of the present invention; and

FIG. 4 is a schematic functional block diagram of a laser transmitter including an external cavity laser assembly, consistent with embodiments of the present disclosure.

### DETAILED DESCRIPTION

An external cavity laser assembly, consistent with embodiments described herein, includes an external chirped exit reflector configured to reduce changes in reflectivity, thereby improving linearity. The chirped exit reflector may be configured to provide a reflectivity profile with a substantially flat peak portion, for example, as compared to the reflectivity profile of a uniform period fiber Bragg grating. The chirped exit reflector may also be configured such that an optical cavity length of the external cavity laser is shorter for higher wavelengths, thereby reducing wavelength fluctuations and changes in reflectivity caused by wavelength fluctuations.

Referring to FIG. 2, one embodiment of an external cavity laser assembly 200 is shown and described in greater detail. The external cavity laser assembly 200 generally includes a laser source 210, such as a semiconductor diode laser, and an optical waveguide 220, such as an optical fiber. The optical waveguide 220 provides an external chirped exit reflector 222, such as a chirped fiber Bragg grating, optically coupled to the laser source 210. The laser source 210 and the optical waveguide 220 may be aligned and coupled using techniques known to those skilled in the art. The optical waveguide 220 may be optically coupled directly to the laser source 210 or may be optically coupled with one or more lenses (not shown) located between the laser source 210 and the optical waveguide 220. Although an exemplary embodiment includes a semiconductor diode laser and optical fiber, other laser sources and optical waveguides may also be used.

As used herein, the term “coupled” may refer to mechanical, optical and/or electrical coupling and does not imply a direct coupling or connection unless otherwise specified. As used herein, the term “optically coupled” refers to at least one coupled element being adapted to impart light to another coupled element directly or indirectly. As used herein, “reflect” refers to the redirection of at least a portion of incident radiation back towards its point of origin and does not require reflection of all radiation nor does it require reflection at any particular angle. As used herein, “reflector” refers to any element or structure capable of reflecting and “chirped” refers to a reflector characteristic such that different wavelengths reflect at different locations along the reflector. As used herein, “reflectivity” refers to the fraction of incident radiation reflected by a particular reflector.

In the exemplary embodiment, the laser source 210 includes an active region 212 located between a rear facet 214 and a front facet 216 of the laser structure and includes a back reflector 218 located proximate the rear facet 214. The back reflector 218 may include a mirror formed on the rear facet 214, for example, using a reflective coating on the rear facet 214. Additionally or alternatively, the back reflector 218 may include a diffraction grating, such as a Bragg grating when the laser source 210 is a distributed Bragg reflector (DBR) laser. The front facet 216 may include an anti-reflection coating to allow light to pass between the laser source 210 and the waveguide 220 with reduced reflection. The back reflector 218, the active region 212, and the external chirped exit reflector 222 together form a laser cavity. When an electrical current is applied to the laser source 210, laser light is generated in the active region 212 and is reflected between the back reflector 218 and the external chirped exit reflector 222. The laser light is amplified by stimulated emission until the light passes through the exit reflector 222 resulting in laser emission or light output into the optical waveguide 220.

The external chirped exit reflector 222 may be a distributed Bragg reflector including alternating layers or regions of varying refractive index such that reflectivity is provided for a wavelength range around a certain wavelength that fulfills the Bragg condition (referred to as the Bragg wavelength λ_{B}). The spacing between the layers or regions may be referred to as the optical period or the grating period. The distributed Bragg reflector may have an optical period that varies linearly or nonlinearly over its length such that the distributed Bragg reflector is chirped. In other words, the Bragg wavelength λ_{B} in a chirped distributed Bragg reflector varies along the length of the reflector and different frequency components of an incident optical pulse (i.e., different wavelengths) are reflected at different points depending on where the Bragg condition is satisfied locally.

According to the exemplary embodiment in which the optical waveguide 220 is an optical fiber, for example, the chirped exit reflector 222 may be a chirped fiber Bragg grating formed in the optical fiber. A fiber Bragg grating is generally a perturbation of the effective refractive index in the core of an optical fiber, using techniques known to those skilled in the art, to form the alternating regions of varying refractive index. In particular, the refractive index may be modulated according to an index modulation function to provide a desired index profile. A chirped fiber Bragg grating may have a grating period that varies linearly or nonlinearly along the length of the fiber grating. In one embodiment, the chirped fiber Bragg grating may also be apodized such that the strength of the refractive index modulation approaches zero at the ends of the grating and is ramped up and down along the grating.

The chirped exit reflector 222 may be configured with one or more reflector characteristics that reduces the change in reflectivity of the exit reflector and thus reduces changes in the front to back reflectivity ratio (i.e., the ratio between the reflectivity of the exit reflector 222 and the back reflector 218). Reducing the changes in the reflectivity ratio leads to a corresponding reduced change the shifting of power distribution in the laser cavity, thereby improving linearity.

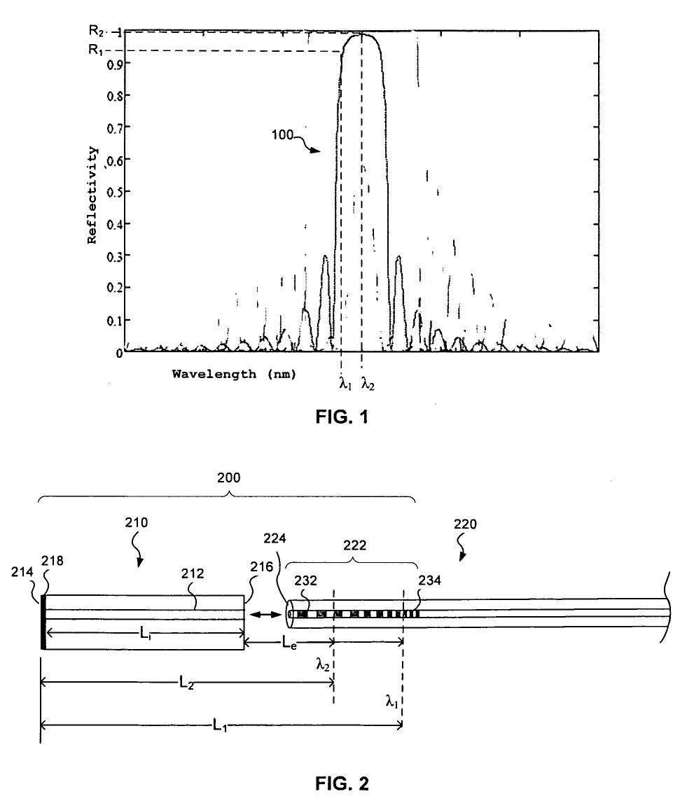

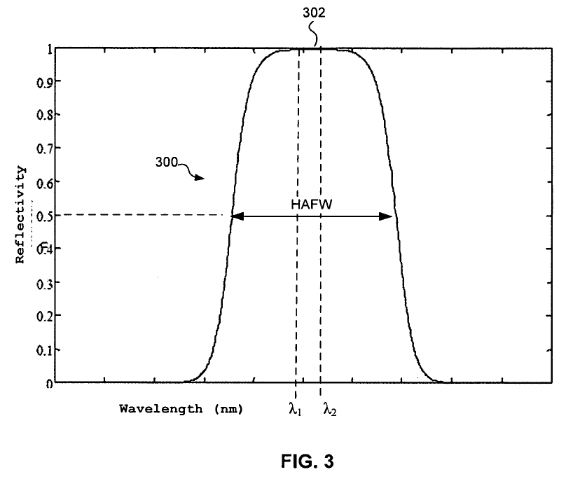

The chirped exit reflector 222 may reduce changes in the reflectivity ratio by providing substantially the same reflectivity over a portion of wavelengths within the reflected wavelength range such that the reflectivity profile has a substantially flat peak, for example, as compared to the reflectivity profile of a uniform period fiber Bragg grating. FIG. 3 shows one example of a reflectivity profile 300 having a flatter peak portion 302 than the peak portion of the reflectivity profile 100 shown in FIG. 1 for a uniform period fiber Bragg grating. As shown, different wavelengths λ₁ and λ₂ have substantially the same reflectivity R on the reflectivity profile 300. Thus, if a change in drive current results in a change in refractive index in the active region 212 and a corresponding change of wavelength from λ₁ and λ₂, the change in reflectivity of a chirped exit reflector with the reflectivity profile 300 is negligible. As such, the chirped exit reflector 222 may be configured to provide a flatter reflectivity profile (e.g., as shown in FIG. 3) to reduce the changes in front to back reflectivity ratio. As used herein, “substantially flat” and “substantially the same reflectivity” may refer to a peak that is flat or without any variation in reflectivity over a range of wavelengths or may include negligible variations in reflectivity resulting in negligible shifting of power distribution within acceptable tolerances for a particular system.

The range of wavelengths reflected by the chirped exit reflector 222 with substantially the same reflectivity may be determined based on the modal operation of the external cavity laser assembly 200. The chirped exit reflector 222 may provide sufficient reflectivity (i.e., above a lasing threshold reflectivity) at a range of wavelengths to support lasing at those wavelengths (referred to as the lasing reflectivity bandwidth). The external cavity laser assembly 200 may be capable of lasing at a plurality of frequencies or wavelengths depending upon the length of the laser cavity (referred to as longitudinal modes or cavity modes). Thus, lasing may occur at wavelengths where there is a cavity mode (referred to as cavity mode wavelengths) and where the reflectivity of the chirped exit reflector 222 is large enough to support lasing. In other words, lasing may occur at cavity mode wavelengths that intersect or fall within the lasing reflectivity bandwidth. To provide only single mode operation, the chirped exit reflector 222 may be configured with a lasing reflectivity bandwidth that includes only one cavity mode wavelength generated by the laser source 210.

The lasing reflectivity bandwidth may be related to the width of the reflectivity profile at half its peak amplitude referred to as the half-amplitude full-width (HAFW) parameter (or alternatively the full width at half maximum (FWHM) parameter) of the reflectivity profile. If the HAFW parameter (and thus the reflectivity bandwidth) of the reflectivity profile is too broad, then a plurality of cavity modes may intersect with a sufficiently high reflectivity to permit lasing and multimode lasing may occur. To provide both a substantially flat reflectivity profile and single mode operation, therefore, the chirped exit reflector 222 may be configured such that the HAFW parameter is as wide as possible without including more than one of the cavity mode wavelengths of the laser source 210.

Thus, the external chirped exit reflector 222 may be a chirped distributed Bragg reflector (e.g., a chirped fiber Bragg grating) that provides a reflectivity profile with a substantially flat peak portion and HAFW parameter that is maximized without permitting multimode operation. The reflectivity profile of a distributed Bragg reflector (e.g., a fiber Bragg grating) may be based on the variation of the optical period and/or the variation of the refractive index modulation. According to one embodiment, the external chirped exit reflector 222 is a chirped distributed Bragg reflector (e.g., a chirped fiber Bragg grating) in which the optical period (or grating period) varies linearly over its length to provide the substantially flat peak of the reflectivity profile. The chirped distributed Bragg reflector may also be configured with a chirped grating period that provides a reflectivity profile with the desired HAFW parameter depending upon the cavity modes of the laser source 210.

To further achieve substantially flat reflectivity, the chirped exit reflector 222 may use an apodized fiber Bragg grating in which the refractive index varies according to an index modulation function that is based on a sinc function (i.e., sin(x)/x). The resulting index profile thus has an envelope that follows the sinc function. According to one example, the index n may be defined according to the following index modulation function:

n=n0+n1*sin(x)*sin c(ax) (1)

where n0 is the average refractive index of the fiber core, n1 is the change of the refractive index of the grating layer, x is a function of the position along the length of the grating, and a is a constant that depends on the design as known to those skilled in the art. Because the Fourier transform of the sinc function is a rectangle function, a refractive index modulation that is based on the sinc function may achieve a flat or square reflectance in the frequency domain.

The chirped exit reflector 222 may also reduce changes in reflectivity ratio by providing a laser cavity with an optical cavity length that varies with changes in wavelength such that wavelength variations and the resulting changes in reflectivity of the exit reflector 222 are reduced. In one embodiment, the chirped exit reflector 222 may be a chirped distributed Bragg reflector configured such that a section 232 with a longer optical period is located proximate the coupled end 224 of the optical waveguide 220 and a section 234 with a shorter optical period is located distal from the coupled end 224 of the optical waveguide 220. In a chirped fiber Bragg grating consistent with one embodiment, for example, the grating period may vary linearly with longer period gratings proximate the coupled end 224 and shorter period gratings distal from the coupled end 224. With this configuration, higher wavelengths are reflected earlier and shorter wavelengths travel further into the chirped exit reflector 222 before being reflected. As such, the length of the optical cavity decreases with increases in wavelength.

Because cavity mode wavelengths are related to the optical cavity length, changes in wavelength caused by changes in refractive index can be mitigated by decreasing the optical cavity length with increases in wavelength. As illustrated in FIG. 2, for example, an internal portion of the laser cavity within the laser source 210 has a length Lᵢ from the back reflector 218 to the front facet 216 and an external portion of the laser cavity external to the laser source 210 has a length Lₑ from the front facet 216 of the laser source 210 to the effective reflection point of the chirped exit reflector 222. As discussed above, the external cavity laser assembly 200 may be capable of multiple lasing cavity modes as determined by the equation:

m=2n(Lᵢ+Lₑ) (2)

where m is an integer, n is the refractive index of the active region, Lᵢ is the optical cavity length of the internal cavity portion of the optical cavity laser, and Lₑ is the optical cavity length of the external cavity portion of the optical cavity laser. Cavity modes that intersect with the lasing reflectivity bandwidth of the chirped exit reflector 222 can support lasing. Equation (2) illustrates that changes in the refractive index n causes changes in the lasing wavelength λ, and changes in drive current applied to the active region 212 may cause changes in the refractive index n of the active region 212. If the change in drive current causes the refractive index n to increase and the length of the laser cavity (Lᵢ+Lₑ) were fixed, for example, the lasing wavelength λ would increase pursuant to equation (2).

When the chirped exit reflector 222 is configured with longer optical periods proximate the coupled end 224, however, the length Lₑ of the external portion of the laser cavity decreases with increases in the wavelengths being reflected. As shown in FIG. 2, for example, light at a longer wavelength λ₂ is reflected earlier than light at the shorter wavelength λ₁ and thus the total optical cavity length L₂ is shorter for the longer wavelength λ₂ than the total optical cavity length L₁ for the shorter wavelength λ₁. Referring back to equation (2), if the change in drive current causes the refractive index n to increase, the lasing wavelength λ may not increase as much because the length Lₑ of the external portion of the laser cavity decreases as the wavelength λ increases. In other words, the change in the optical cavity length Lₑ of the external cavity portion with changes in wavelength is opposite to or counteracts the changes in the refractive index n that cause the wavelength to change, thereby mitigating the changes in wavelength caused by changes in the refractive index n. As such, when the longer optical period is located proximate the coupled end 224, the reflectivity of the chirped exit reflector 222 may not vary as much with changes in drive current, even if the reflectivity profile is similar to that of a uniform period fiber Bragg grating as shown in FIG. 1, because the wavelength does not vary as much. Thus, providing a chirped distributed Bragg reflector (e.g., a chirped fiber Bragg grating) arranged with the longer optical periods proximate the coupled end may also reduce the change in reflectivity ratio independent of the reflectivity profile, thereby reducing the resulting shift in power distribution and improving linearity.

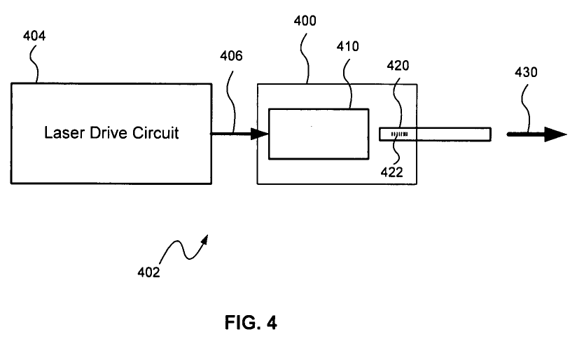

Referring to FIG. 4, an external cavity laser assembly 400, according to any of the embodiments described above, may be used in a laser transmitter 402 including a laser drive circuit 404. The external cavity laser assembly 400 may include a laser source 410 electrically coupled to the laser drive circuit 404 and optically coupled to an optical waveguide 420 including a chirped exit reflector 422, as discussed above. One example of the laser transmitter 402 is a laser transmitter designed for CATV applications, such as the type available from Applied Optoelectronics, Inc. In such “broadband” applications, the laser transmitter 402 and particularly the external cavity laser assembly 400 may be designed for high frequency operation, for example, up to about 1 GHz, and the external cavity laser assembly 400 may be configured for operation at wavelengths such as 1310 nm and 1550 nm. This example of the laser transmitter 402 may also include other components, such as an RF amplifier, a thermoelectric cooler (TEC) controller, a microcontroller, a predistortion circuit, and/or a clipping correction circuit, as well as other components known to those skilled in the art for use in a laser transmitter. Embodiments of the external cavity laser assembly may also be used in other types of laser transmitters used in other communications applications or in other non-communications applications, such as chemical sensing.

The laser drive circuit 404 may include circuitry known to those skilled in the art for providing at least a modulation current 406 to the external cavity laser assembly 400. The laser drive circuit 404 may also provide other currents to the external cavity laser assembly 400 such as a laser threshold current and/or a bias current. The external cavity laser assembly 400 receives the modulation current 406 and generates a modulated light output 430 in response to the modulation current 406. Thus, the modulation of the light occurs within the cavity of the external cavity laser assembly 400. Nonlinearities that may occur within the laser cavity when directly modulating the external cavity laser assembly 400 may be reduced by using an external cavity laser assembly 400 that includes a chirped exit reflector 422, such as a chirped fiber Bragg grating, having one or more of the characteristics described above.

Accordingly, embodiments of the external cavity laser assembly described herein use a chirped exit reflector that reduces reflectivity ratio changes, which reduces shifting of power from front to rear of the laser cavity and thus reduces non-linearity.

Consistent with one embodiment, an external cavity laser assembly includes a laser source including an active region, a back reflector, and an exit facet. The laser source is configured to receive an electrical input and to generate laser light in response to the electrical input, and the exit facet is configured to allow the laser light to pass through. The external cavity laser assembly also includes an optical waveguide external to and optically coupled to the laser source. The optical waveguide includes a coupled end optically coupled to the laser source and a chirped exit reflector proximate the coupled end and configured to reflect laser light within a range of wavelengths. The back reflector and the chirped exit reflector define a laser cavity with the active region therebetween. The chirped exit reflector is configured to reflect at least a portion of the range of wavelengths with substantially the same reflectivity.

Consistent with another embodiment, an external cavity laser assembly includes a laser source including an active region, a back reflector, and an exit facet. The laser source is configured to receive an electrical input and to generate laser light in response to the electrical input, and the exit facet is configured to allow the laser light to pass through. The external cavity laser assembly also includes an optical waveguide external to and optically coupled to the laser source. The optical waveguide includes a coupled end optically coupled to the laser source and a chirped exit reflector proximate the coupled end and configured to reflect laser light within a range of wavelengths. The back reflector and the chirped exit reflector define a laser cavity with the active region therebetween. The chirped exit reflector is configured to reflect higher wavelengths within the range of wavelengths at shorter distances from the coupled end of the optical waveguide such that an optical cavity length is shorter for higher wavelengths.

Consistent with a further embodiment, a laser transmitter includes a laser drive circuit configured to provide at least a modulation current and an external cavity laser assembly configured to receive the modulation current and configured to generate a modulated light output in response to the modulation current. The external cavity laser assembly includes a laser source including an active region, a back reflector, and an exit facet. The laser source is configured to receive an electrical input and to generate laser light in response to the electrical input, and the exit facet is configured to allow the laser light to pass through. The external cavity laser assembly also includes an optical waveguide external to and optically coupled to the laser source. The optical waveguide includes a coupled end optically coupled to the laser source and a chirped exit reflector proximate the coupled end and configured to reflect laser light within a range of wavelengths. The back reflector and the chirped exit reflector define a laser cavity with the active region therebetween. The chirped exit reflector is configured to reflect at least a portion of the range of wavelengths with substantially the same reflectivity. The chirped exit reflector is configured to reflect higher wavelengths within the range of wavelengths at shorter distances from the coupled end of the optical waveguide such that an optical cavity length is shorter for higher wavelengths.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. An external cavity laser assembly, comprising:
a laser source including an active region, a back reflector, and an exit facet, the laser source being configured to receive an electrical input and to generate laser light in response to the electrical input, and wherein the exit facet is configured to allow the laser light to pass through; and
an optical waveguide external to and optically coupled to the laser source, the optical waveguide including a coupled end optically coupled to the laser source and a chirped exit reflector proximate the coupled end and configured to reflect laser light within a range of wavelengths, wherein the back reflector and the chirped exit reflector define a laser cavity with the active region therebetween, and wherein the chirped exit reflector is configured to reflect at least a portion of the range of wavelengths with substantially the same reflectivity.

2. The external cavity laser assembly of claim 1 wherein the laser source is capable of a plurality of cavity modes at a plurality of cavity mode wavelengths, and wherein a lasing reflectivity bandwidth of the chirped exit reflector is sufficiently narrow to include only one of the plurality of cavity mode wavelengths.

3. The external cavity laser assembly of claim 1 wherein the laser source is capable of a plurality of cavity modes at a plurality of cavity mode wavelengths, wherein the chirped exit reflector provides a reflectivity profile having a half-amplitude full-width (HAFW) parameter, wherein the chirped exit reflector is configured such that the HAFW parameter is as wide as possible without including more than one of the plurality of cavity mode wavelengths.

4. The external cavity laser assembly of claim 1 wherein the optical waveguide is an optical fiber, and wherein the chirped exit reflector is a chirped fiber Bragg grating.

5. The external cavity laser assembly of claim 4 wherein the chirped fiber Bragg grating has a refractive index that varies according to an index modulation function that is based on a sinc function.

6. The external cavity laser assembly of claim 4 wherein the fiber Bragg grating is apodized.

7. The external cavity laser assembly of claim 4 wherein the chirped fiber Bragg grating has an optical period that varies over a length of the chirped fiber Bragg grating, and wherein the optical period of a section of the chirped fiber Bragg grating proximate the coupled end of the optical fiber is longer than the optical period of a section of the chirped fiber Bragg grating distal to the coupled end of the optical fiber.

8. An external cavity laser assembly, comprising:
a laser source including an active region, a back reflector, and an exit facet, the laser source being configured to receive an electrical input and to generate laser light in response to the electrical input, and wherein the exit facet is configured to allow the laser light to pass through; and
an optical waveguide external to and optically coupled to the laser source, the optical waveguide including a coupled end optically coupled to the laser source and a chirped exit reflector proximate the coupled end and configured to reflect laser light within a range of wavelengths, wherein the back reflector and the chirped exit reflector define a laser cavity with the active region therebetween, and wherein the chirped exit reflector is configured to reflect higher wavelengths within the range of wavelengths at shorter distances from the coupled end of the optical waveguide such that an optical cavity length is shorter for higher wavelengths.

9. The external cavity laser assembly of claim 8 wherein the chirped exit reflector is configured to reflect at least a portion of the range of wavelengths with substantially the same reflectivity.

10. The external cavity laser assembly of claim 9 wherein the laser source is capable of a plurality of cavity modes at a plurality of cavity mode wavelengths, and wherein a lasing reflectivity bandwidth of the chirped exit reflector is sufficiently narrow to include only one of the plurality of cavity mode wavelengths.

11. The external cavity laser assembly of claim 8 wherein the laser source is capable of a plurality of cavity modes at a plurality of cavity mode wavelengths, wherein the chirped exit reflector provides a reflectivity profile having a half-amplitude full-width (HAFW) parameter, wherein the chirped exit reflector is configured such that the HAFW parameter is as wide as possible without including more than one of the plurality of cavity mode wavelengths.

12. The external cavity laser assembly of claim 8 wherein the optical waveguide is an optical fiber.

13. The external cavity laser assembly of claim 12 wherein the chirped exit reflector includes a chirped fiber Bragg grating, the chirped fiber Bragg grating having an optical period that varies over a length of the chirped fiber Bragg grating, and wherein the optical period of a section of the chirped fiber Bragg grating proximate the coupled end of the optical fiber is longer than the optical period of a section of the chirped fiber Bragg grating distal to the coupled end of the optical fiber.

14. The external cavity laser assembly of claim 8 wherein the optical waveguide is an optical fiber, and wherein the chirped exit reflector is a chirped fiber Bragg grating.

15. The external cavity laser assembly of claim 14 wherein the chirped fiber Bragg grating has a refractive index that varies according to an index modulation function that is based on a sinc function.

16. The external cavity laser assembly of claim 14 wherein the fiber Bragg grating is apodized.

17. The external cavity laser assembly of claim 8 wherein the laser source is a distributed Bragg reflector (DBR) laser, and wherein the rear reflector is a distributed Bragg reflector.

18. The external cavity laser assembly of claim 8 wherein the optical cavity length changes with a change in wavelength opposite to a change in refraction index of the laser source that causes the change in wavelength.

19. A laser transmitter comprising:
a laser drive circuit configured to provide at least a modulation current; and
an external cavity laser assembly configured to receive the modulation current and configured to generate a modulated light output in response to the modulation current, the external cavity laser assembly comprising:
a laser source including an active region, a back reflector, and an exit facet, the laser source being configured to receive the modulation current and to generate laser light in response to the electrical input, and wherein the exit facet is configured to allow the laser light to pass through; and
an optical waveguide external to and optically coupled to the laser source, the optical waveguide including a coupled end optically coupled to the laser source and a chirped exit reflector proximate the coupled end and configured to reflect laser light within a range of wavelengths, wherein the back reflector and the chirped exit reflector define a laser cavity with the active region therebetween, wherein the chirped exit reflector is configured to reflect at least a portion of the range of wavelengths with substantially the same reflectivity, and wherein the chirped exit reflector is configured to reflect higher wavelengths within the range of wavelengths at shorter distances from the coupled end of the optical waveguide such that an optical cavity length is shorter for higher wavelengths.

20. The laser transmitter of claim 19 wherein the optical waveguide is an optical fiber, and wherein the chirped exit reflector is a chirped fiber Bragg grating.

21. The laser transmitter of claim 20 wherein the chirped fiber Bragg grating has an optical period that varies over a length of the chirped fiber Bragg grating, and wherein the optical period of a section of the chirped fiber Bragg grating proximate the coupled end of the optical fiber is longer than the optical period of a section of the chirped fiber Bragg grating distal to the coupled end of the optical fiber.

22. The laser transmitter of claim 20 wherein the chirped fiber Bragg grating has a refractive index that varies according to an index profile based on a sinc function.
